(19) United States
(12) Patent Application Publication
(10) Pub. No.: US 2005/0251920 A1
(43) Pub. Date: Nov. 17, 2005

(54) Structure of pocket spring set for matress and manufacturing method thereof

(76) Inventor: Sung Ho Ahn, Kyunggi-Do (KR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/505,870

(22) PCT Filed: Dec. 23, 2003
(86) PCT No.: PCT/KR03/02806

§ 371 Date: Aug. 27, 2004

(30) Foreign Application Priority Data
Jan. 7, 2003 (KR) 10-2003-0000764

(51) Int. Cl. B68G 7/00; A47C 23/04

(52) U.S. Cl. 5/716; 29/91.1

(57) ABSTRACT

The invention is a pocket spring assembly built in a mattress for independently providing cushioning or shock-absorbing performance, the pocket spring assembly. The pocket spring assembly includes a pocket set (10) with a plurality of pockets (12) each accommodating a coil spring (11) arranged regularly in a longitudinal direction (R) and a transversal direction (C); a plurality of helical coils (20) threadly engaged to an upper surface of the pocket set (10) in the horizontal direction (R) for fixing an upper end turn of the coil spring (11); and a non-woven fabric (40) attached to an upper portion of the pocket set (10) for fixing the upper portion of the pocket set (10).

### TECHNICAL FIELD

The present invention relates to a pocket spring built in a mattress for providing a desirable level of cushioning or shock-absorbing performance, and more particularly, to a pocket spring assembly capable of providing a dual cushioning function using a single cushion member by modifying a structure of a coil spring, and a method of manufacturing the pocket spring assembly.

### BACKGROUND ART

Recently, one or more mattresses are mounted on a bed frame to provide cushioning or shock-absorbing performance, and includes a spring assembly with coil springs arranged in a longitudinal direction and a transversal direction within an accommodating space of a frame member, fabric or foamed cushion members each layered on upper and lower surfaces of the spring assembly and a peripheral surface of the spring assembly, and cover members each covering upper and lower surfaces of the cushion member and a peripheral surface of the cushion member.

The mattress is constructed in such a way that the coil springs of the spring assembly mattress are engaged to each other in the longitudinal direction and the transversal direction and are moved in combination with each other. Shock applied to the mattress is transferred to an adjacent coil spring to thereby produce undulation. Therefore, comfortableness of the mattress is reduced, thereby disturbing sleep.

In order to solve the above problem of the spring assembly, it has been proposed that a pocket spring assembly including a pocket set with pockets each accommodating a coil spring is arranged in a longitudinal direction and a transversal direction within an accommodating space of a frame member, and a flexible fabric member covering the pocket set.

As shown in FIGS. 1 to 3, a pocket spring assembly 100 includes a pocket set 110 with pockets 112 each accommodating a coil spring arranged regularly in a longitudinal direction R and a transversal direction C, frame members 120 and 120′ each provided on upper and lower portions of the pocket set 110 for fixing turns of the outermost coil springs among coil springs 111, and non-woven fabrics 130 and 130′ attached to upper and lower surfaces of the frame members 120 and 120′,

A pocket 112 of the pocket set 110 forms a space for accommodating the coil spring 111 therein. Upper and lower portions of the pocket are attached to a periphery surface of the pocket by a hot melting process to seal the coil spring.

The pocket set 110 is arranged in a row direction C in such a way that melting portions 112a, provided to both sides of a body of the pocket 112, are adhered to melting portions of adjacent pockets by the hot melting process. Then, the periphery surface of the pocket 112 arranged in a row is applied with an adhesive 112b, and is adhered to adjacent pocket set constructed as described.

The non-woven fabrics 130 and 130′ are laid on the upper and lower portions of the pocket set 110, and the frame members 120 and 120′ are positioned around the pocket sets. Upper and lower end turns of the outermost springs among the coil spring 111 are fixed to the periphery surfaces of the frame members 120 and 120′ by fixing members 140. The manufacture of the pocket spring assembly 100 is completed by the above process.

The cushion member, such as fabric or foamed material, is adhered to the upper and lower surfaces of the pocket spring assembly 100, and is enclosed by the cover member. Accordingly, varying external shock applied to the mattress is independently absorbed by the coil springs 111 arranged in the pocket sets 110.

The pockets 112 arranged in the pocket spring assembly 100 are engaged to each other by the melting portions 112a and the adhesive 112b, and are moved in combination with each other. Therefore, there is a problem that the shock applied to the mattress is transferred to the adjacent pockets via the melting portions 112a of the pocket 112 and the adhesive 112b to thereby produce the undulation.

Specifically, the load applied to the mattress is indirectly transferred to the adjacent coil springs via the coil spring 111 accommodated in the pocket 112, so that the adjacent coil spring is inclined in a direction of the load applied to the coil spring 111. Therefore, the load of the sleeping person cannot be absorbed perfectly.

In the process of manufacturing the pocket set 110, steps of applying the adhesive 112b on the periphery of the pockets 112 arranged in a row and adhering the pockets with another pockets arranged in a row are required. Unfortunately, such a process is time consuming and inefficient, thereby increasing the cost of the pocket spring assembly.

In addition, since the upper and lower non-woven fabrics 130 and 130′ are adhered to the upper and lower surfaces of the pocket set 110, respectively, such a process is time consuming and inefficient. Further, there is another problem of increasing additional cost of the pocket spring assembly, because of waste of upper and lower non-woven fabrics.

According to the pocket spring assembly 100, the coil springs are arranged so that the upper portion of the body has the same cushioning performance as that of the lower portion of the body. In order to provide the pocket spring assembly 100 with the function of a dual cushion using a single cushion member, the material of the cushion member layered on the upper surface of the pocket spring assembly 100 has to be different from that of the lower surface.

### DISCLOSURE OF THE INVENTION

The present invention solves the problems involved in the prior art, and provides a pocket spring assembly capable of providing a dual cushioning function using a single cushion member by modifying a structure of a coil spring, and a method of manufacturing the pocket spring assembly.

In order to accomplish the above and other objects, there is provided a pocket spring assembly built in a mattress for independently providing cushioning or shock-absorbing performance, the pocket spring assembly comprising: a pocket set with a plurality of pockets each accommodating a coil spring arranged regularly in a longitudinal direction and a transversal direction; a plurality of helical coils threadly engaged to an upper surface of the pocket set in a horizontal direction for fixing an upper end turn of the coil spring; upper and lower frame members each provided to upper and lower portions of the pocket set for fixing an outermost coil spring among the coil springs; and a non-woven fabric attached to an upper portion of the pocket set for fixing the upper portion of the pocket set.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a top plan view illustrating a conventional pocket spring assembly.

FIG. 2 is a front view illustrating a conventional pocket spring assembly.

FIG. 3 is a side view illustrating a conventional pocket spring assembly.

FIG. 4 is a top plan view illustrating a pocket spring assembly according to a preferred embodiment of the present invention.

FIG. 5 is a front view illustrating a pocket spring assembly according to a preferred embodiment of the present invention.

FIG. 6 is a side view illustrating a pocket spring assembly according to a preferred embodiment of the present invention.

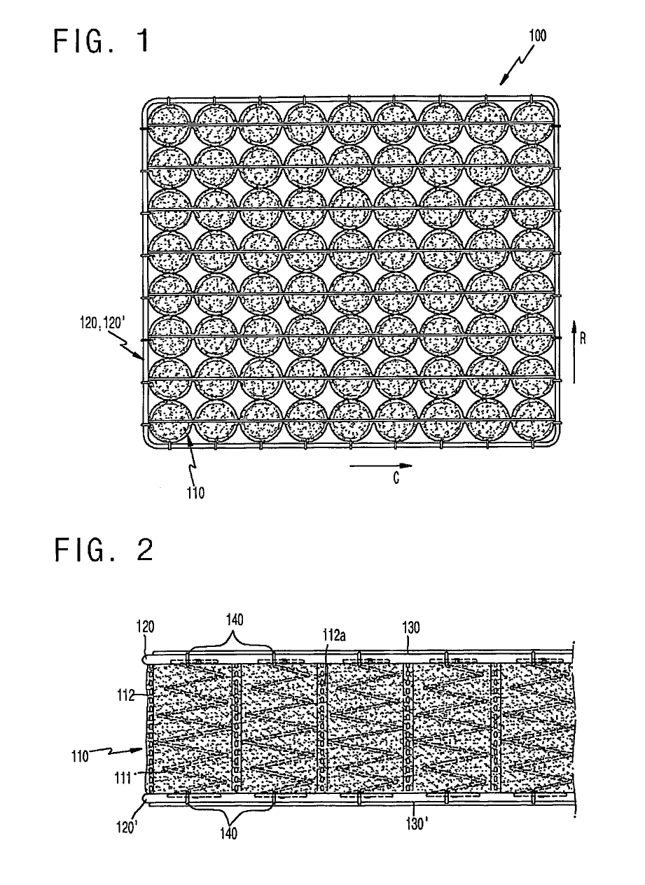

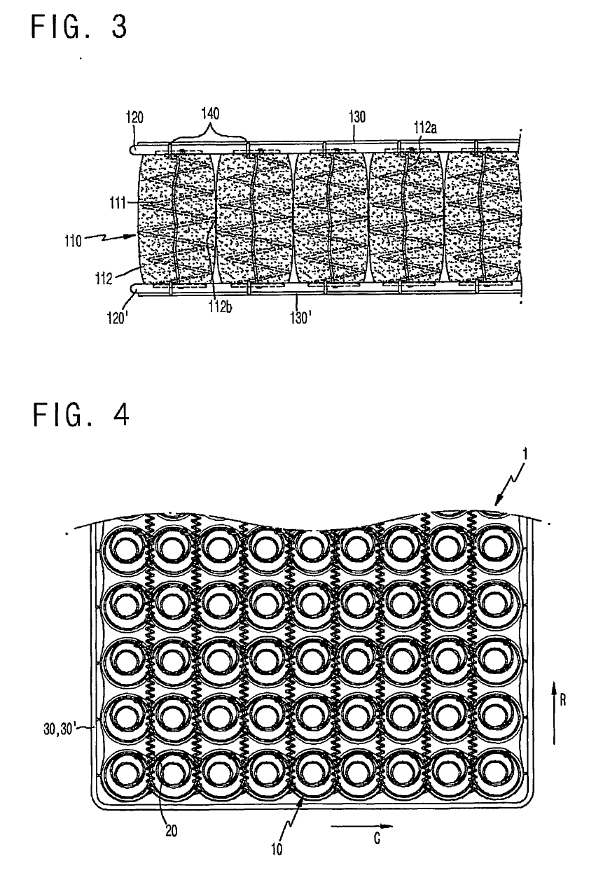

### BEST MODE FOR CARRYING OUT THE INVENTION

Reference will now be made in detail to preferred embodiments of the present invention, examples of which are illustrated in the accompanying drawings.

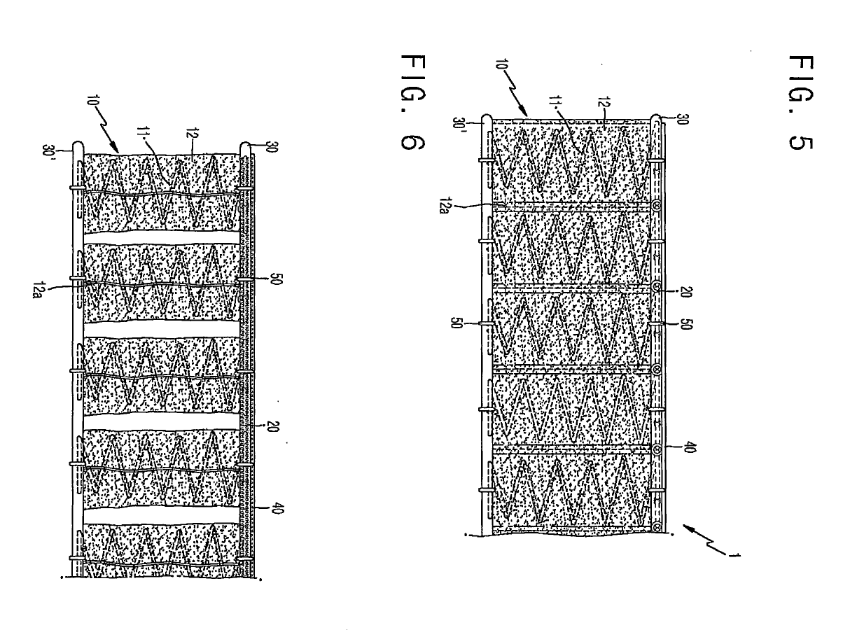

FIG. 4 is a top plan view illustrating a pocket spring assembly according to a preferred embodiment of the present invention, FIG. 5 is a front view of the pocket spring assembly, and FIG. 6 is a side view of the pocket spring assembly. The pocket spring assembly of the present invention includes a pocket set 10 with a plurality of pockets 12 each accommodating a coil spring 11 arranged regularly in a longitudinal direction R and a transversal direction C, a helical coil 20 threadly coupled to an upper surface of the pocket set 10 in a horizontal direction R for fixing an upper end turn of the coil spring 11, upper and lower frame members 30 and 30′ each provided to upper and lower portions of the pocket set 10 for fixing the outermost coil spring among the coil springs 11 by a fixing member 50, and a non-woven fabric 40 attached to an upper portion of the frame member 30 for fixing an upper portion of the pocket set 10 and the helical coil 20.

A method of manufacturing the pocket spring assembly comprises the steps of inserting individual coil spring 11 into an accommodating space of the pocket 12 and sealing the accommodating space, adhering a plurality of pockets using melting portions 12a formed at both sides of the pocket 12 and arranging the pockets in a row direction C, arranging the row of pockets 12 in a horizontal direction R to form the pocket set 10, threadly engaging the helical coil 20 to the upper surface of the pocket set 10 in the horizontal direction R to fix an upper end turn of the coil spring 11, providing upper and lower portions of the pocket set 10 with the upper and lower frame members 30 and 30′ and fixing the outermost coil spring among the coil springs 11 by the fixing member 50, respectively, and mounting the helical coil 20 to the frame member 30, with the non-woven fabric 40 being laid on the upper surface of the frame member.

Among components of the present invention, the coil spring I 1 and the pocket 12 of the pocket set 10, the frame members 30 and 30′, and the non-woven fabric 40 have the same function and material as those of the prior art, and thus the description thereof will be omitted herein. However, components different from those of the prior art are indicated by reference numeral and are described herein.

The direction in which the pockets 12 are continuously adhered to each other by the melting portions 12a is referred to as the row direction C as shown in FIG. 5, and the direction which rows of pockets 12 are continuously arranged is referred to as the horizontal direction R as shown in FIG. 6. The row direction C may be changed into the horizontal direction R, and vice versa.

The pocket 12 has a body made of a natural fabric, and forms an accommodating space IN the body. The pocket 12 also has an opening for receiving the coil spring 11 at an upper portion of the body, and melting portions 12a formed on both sides of the body for adhering to an adjacent pocket by a hot melting process.

The coil spring 11 comprises a triple offset spring, a double offset spring, a lux spring and a cozy spring, which are applied to a conventional spring assembly. Preferably, a spring having upper and lower turns formed at upper and lower ends of the body in a round shape is utilized.

The coil spring 11 has the nearly same height as that of the accommodating space of the pocket and the nearly same diameter as that of the accommodating space of the pocket. Therefore, even though additional supporting means is not provided, the coil spring 11 may maintain supporting power to maximize the cushioning performance in the state it is built in the accommodating space of the pocket 12.

Since one side (upper surface) of the pocket set 10 is fixed by a plurality of helical coils 20 and the other side (lower surface) is not fixed by separate fixing means, the pocket spring assembly 1 may function as a dual cushioning performance using a single cushion, even through the cushioning of the upper and lower surfaces of the pocket set 10 is different from each other.

Although the arrangement of the upper and lower frame members 30 and 30′ on the upper and lower portions of the pocket set 10 is described in this embodiment, the upper and lower frame members 30 and 30′ may be eliminated if the pocket set 10 is supported by various cushioning members mounted to the upper and lower surfaces and the periphery of the pocket spring assembly 1.

Further, in this embodiment, one side (upper surface) of the pocket set 10 is fixed by the helical coils 20 and the other side (lower surface) is not fixed by separate fixing means. However, an adhesive is applied on the row of the pockets 112, and another row of pockets can be adhered to the row of the pockets.

The method of manufacturing the pocket spring assembly of the present invention will be described in detail.

First, in order to manufacture the pocket spring assembly 10, an individual coil spring 11 is inserted into the accommodating space of the pocket 12, and the accommodating space is sealed. A plurality of pockets are continuously adhered to each other in a row by use of the melting portions 12a, as shown in FIG. 5.

Then, the rows of pockets 12 are continuously arranged in a horizontal direction R to form the pocket set 10, as shown in FIG. 6. A plurality of the helical coils 20 are engaged to the upper surface of the pocket set 10 in the horizontal direction R.

The pocket set 10 is arranged in such a way that the upper end turns of the pocket set are engaged to each other by the helical coil 20 and the lower end is expandable in the row direction.

At that time, in the course of arranging regularly the pockets 12 in the horizontal direction R and the row direction C, the adhesive used in the prior art is not required, thereby reducing the working steps.

After the non-woven fabric 40 is adhered to the upper surface of the pocket set 10 by the hot melting process, the frame members 30 and 30′ are laid on the upper and lower portions of the pocket set 10, and the outermost coil spring among the coil springs 11 is fixed to the frame member.

At that time, the non-woven fabric is adhered to the upper surface of the pocket set 10, while any non-woven fabric is not adhered to the lower surface of the pocket set. Therefore, the working steps are reduced and consumption of the non-woven fabric is minimized.

Then, the cushion member, such as fabric or foamed material, is adhered to the upper and lower surfaces and the periphery of the pocket spring assembly 1 to thereby manufacture the mattress. Accordingly, varying external shock applied to the mattress is independently absorbed by the coil springs 11 arranged in the pocket sets 10.

Further, since the upper and lower surfaces of the pocket spring 1 are provided with the different cushioning, the mattress of the present invention may provide the dual cushioning performance. Also, if the material of the cushion material layered on the upper and lower surfaces of the pocket spring assembly 1 is different to each other, the mattress may obtain various cushioning functions.

While the present invention has been described and illustrated herein with reference to the preferred embodiment thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As apparent from the above description, according to the pocket spring assembly according to the present invention, since a dual cushioning function is provided using the single cushion member, various cushioning performances may be provided by one mattress. Further, the non-woven fabric is adhered to the upper surface of the pocket set by the hot melting process, thereby minimizing the loss of peripheral components due to the undulation of the coil springs.

Furthermore, since the rows of pockets are not attached to each other in the pocket set, the load applied to the coil spring is not transferred to the adjacent coil spring, thereby improving the comfortableness and convenience of the mattress. Also, the working steps of manufacturing the pocket spring are reduced to thereby minimize the cost of the pocket spring assembly.

1. A pocket spring assembly built in a mattress for independently providing cushioning or shock-absorbing performance, the pocket spring assembly comprising:
a pocket set with a plurality of pockets each accommodating a coil spring arranged regularly in a longitudinal direction and a transversal direction;
a plurality of helical coils threadly engaged to an upper surface of the pocket set in the horizontal direction for fixing an upper end turn of the coil spring; and
a non-woven fabric attached to an upper portion of the pocket set for fixing the upper portion of the pocket set.

2. The pocket spring assembly as claimed in claim 1, wherein the coil spring of the pocket set includes upper turns formed in a round shape, the upper turns forming an upper end of a body.

3. The pocket spring assembly as claimed in claim 1, wherein the pocket of the pocket set includes melting portions formed at both sides of the pocket in the row direction.

4. A pocket spring assembly built in a mattress for independently providing cushioning or shock-absorbing performance, the pocket spring assembly comprising:
a pocket set with a plurality of pockets each accommodating a coil spring arranged regularly in a longitudinal direction and a transversal direction;
a plurality of helical coils threadly engaged to an upper surface of the pocket set in a horizontal direction for fixing an upper end turn of the coil spring;
upper and lower frame members and each provided to upper and lower portions of the pocket set for fixing an outermost coil spring among the coil springs; and
a non-woven fabric attached to an upper portion of the pocket set for fixing the upper portion of the pocket set.

5. The pocket spring assembly as claimed in claim 4, wherein the coil spring of the pocket set includes upper turns formed in a round shape, the upper turns forming an upper end of the body.

6. The pocket spring assembly as claimed in claim 4, wherein the pocket of the pocket set includes melting portions formed at both sides of the pocket in the row direction.

7. A method of manufacturing a pocket spring assembly built in a mattress for independently providing cushioning or shock-absorbing performance, the method comprising the step of:
inserting individual coil spring into an accommodating space of a pocket and sealing the accommodating space;
continuously adhering a plurality of pockets using melting portions formed at both sides of the pocket and arranging the pockets in a row;
arranging the row of pockets in a horizontal direction to form a pocket set;
threadly engaging a helical coil to an upper surface of the pocket set in a horizontal direction to fix an upper end turn of the coil spring; and
fixing an upper surface of the pocket and the helical coil to an upper portion of the pocket set, with a non-woven fabric being laid on an upper surface of the pocket set.

8. A method of manufacturing a pocket spring assembly built in a mattress for independently providing cushioning or shock-absorbing performance, the method comprising the step of:
inserting individual coil spring into an accommodating space of a pocket and sealing the accommodating space;
continuously adhering a plurality of pockets using melting portions formed at both sides of the pocket and arranging the pockets in row;
arranging the row of pockets in a horizontal direction to form a pocket set;
threadly engaging a helical coil to an upper surface of the pocket set in a horizontal direction to fix an upper end turn of the coil spring;
fixing an outermost coil spring among the coil springs to upper and lower portions of the pocket set by a fixing member, respectively, with upper and lower frame members and being laid on the upper and lower portions of the pocket set; and
fixing the pocket and the helical coil to the upper portion of the pocket set, with a non-woven fabric being laid on an upper surface of the frame member.
